(19) United States
(12) Patent Application Publication
(10) Pub. No.: US 2007/0085680 A1
(43) Pub. Date: Apr. 19, 2007

(54) DEVICE, SYSTEM AND METHOD FOR SECURING CARGO ITEMS

(76) Inventor: Victor Cohen, Be'er Sheva (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/550,890

(22) Filed: Oct. 19, 2006

Related U.S. Application Data
(60) Provisional application No. 60/727,835, filed on Oct. 19, 2005.

(51) Int. Cl. E05B 45/06; G08B 1/08

(52) U.S. Cl. 340/542; 340/539.31

(57) ABSTRACT

A system enabling detection of unauthorized removal of a cargo item 414 from a cargo claim area 420, said system may comprise: a locking device 100 attachable to cargo item 414, wherein locking device 100 may comprises a transmitter 110 adapted to transmit data wirelessly, said data being indicative on whether said locking device is locked or not; a key 170 adapted to unlock said locking device; one or more detectors 424a-d positioned in an manner such that wireless signals transmitted from a plurality of transmitters exiting cargo claim area 420 are detected at detectors 424a-d; and a computing module 430 operatively associated with detectors 424a-d. Computing module 430 may give rise to a suitable response in case computing module 430 determines that data received via said signals is indicative of locking device 100 being locked.

### FIELD OF THE INVENTION

The present invention relates to systems for ensuring the security of cargo items of travelers. More particularly, the present invention relates to systems for preventing misidentification of cargo items' destination and ownership and eliminating unauthorized removal of cargo items from a cargo claim area.

### BACKGROUND

One of the most disturbing phenomena of Current day traveling relates to lost, misplaced and stolen cargo items. For travelers going on vacation or on business trips, receiving checked-in cargo items late or not receiving them at all might prove to have an extremely negative impact on their traveling experience and is very costly to companies transporting cargo items. For example, statistic shows that airlines are forced to pay travelers over one billion and a half US dollars annually to compensate travelers who encounter such problems.

Three principal reasons may cause misplacement of cargo items: errors in identifying the proper destination of a cargo item by company personnel that boards baggage items on, e.g., the wrong flight; travelers who misidentify cargo items and mistakenly collect cargo items that do not belong to them; felons who steal cargo items and cannot be stopped since currently there is no way of validating that the cargo item they arc leaving with a cargo claim area truly belongs to them. There is therefore a need for a system that addresses the above-mentioned problems and helps preventing them. Such a system would need to help terminal personnel validate the destination of cargo items before loading them onto, e.g., an aircraft, a ship and the like, and ensure that travelers do not leave the cargo claim area with cargo items that belong to someone else. Many publications address the above-mentioned problem though none of them provides a comprehensive solution, as will be outlined hereinafter.

For example, U.S. patent application US2005001041 (McCarthy et al.), which is incorporated by reference for all purposes as if fully set forth herein, describes a cargo closure for sealing a cargo item such as a piece of luggage in a closed condition.

U.S. patent application No. US2004246097 (Queenan), which is incorporated by reference for all purposes as if fully set forth herein, describes a latch, or tag that can be used on luggage, baggage, trunks, rail cars, trailers or any compartment that can be opened and closed and that establishes profile data that is associated with the latch or tag and is adapted to store personal data and an identifier in the latch mechanism or on the tag.

U.S. patent application No. US2004246096 (Queenan), which is incorporated by reference for all purposes as if fully set forth herein, describes an electronic lock that can be used on luggage, baggage, rail cars, trailers or any compartment that can be opened and re-locked. The lock provides tracking of when the lock was opened, where the lock was opened and data relating to the key that was used to open the lock.

In patent GB2351961 (Millington), which is incorporated by reference for all purposes as if fully set forth herein, a baggage tag is disclosed adapted to display visual information and which may also possess an electronic ID module.

In U.S. patent application No. US2005005482 (Araujo et al.), which is incorporated by reference for all purposes as if fully set forth herein, describes an intelligent luggage protection pouch according to the present invention that is tamper resistant, easily identifiable, and inspection friendly (i.e., x-ray and canine searchable).

In European patent EP0486973, (Bravman et al.), which is incorporated by reference for all purposes as if fully set forth herein, a bar code is disclosed to identify a traveler's luggage, permitting the luggage to be tracked and, if desired, to he delivered to the traveler's ultimate destination (e.g., a hotel). If the traveler is traveling on an airline, a corresponding bar code is applied to the traveler's boarding pass. A bar code reader is used to read the boarding-pass bar code of each emplaning passenger; comparison of these bar codes with luggage bar-code data permits an alarm to be raised if each item of checked luggage is not matched by an emplaned passenger.

In U.S. Pat. No. US6,476,718 (Cartwright et al.), which is incorporated by reference for all purposes as if fully set forth herein, an apparatus is described for the unique and permanent identification of an article of luggage, said apparatus including a microchip attached to the article of luggage.

In U.S. Pat. No. US6,222,452 (Ahlstrom et al.), which is incorporated by reference for all purposes as if fully set forth herein, an electronic identification tag is made up of at least one cover strip and a carrier strip having an antenna and transponder mounted thereon, and an adhesive to secure the strips together such that the antenna is interposed between the strips, the transponder being pre-programmed to generate a signal having a unique code correlated with indicia on the tag to identify a passenger or luggage. The tag further lends itself well to a novel method of tracking luggage and passengers in a transportation facility.

In U.S. patent application, No. US2005012614 (Brosow), which is incorporated by reference for all purposes as if fully set forth herein, tamperproof recordings are described on the passenger's boarding pass, which have a unique relationship with the identity of the passenger and his luggage, to enhance the security of air traffic. This relationship is monitored from the time the passenger checks in at the departure airport until he leaves the destination airport.

However, none of the above-referenced publications describe a system, device and/or method that effectively prevent unauthorized collecting of cargo items such as, e.g., baggage and the like from a cargo claim area. Persons may still unoticeably take out cargo items, which do not belong to them, from the cargo claim area.

Publication WO9838605 (Shapira), describes a system for verifying the ritual association of a plurality of items belonging to a common set. One or more of the items is a primary item and one or more items is a secondary item. The system includes a plurality of identification devices, each of the identification devices being associated uniquely with one of the items. Each of the identification devices has an identity. The system further includes an electronic monitor capable of establishing the identities and querying the association of each of the secondary items with each of the primary items. The system can be used, for example, to verify ownership of luggage at an airport. However, the system presented by Shapira utilizes a bar code and a bar code reader for the identification whether baggage is correctly associated to the person leaving the baggage claim area. In order to enable identification of the barcode, said barcode has to be suitably aligned to a barcode reader. In consequence, persons who want to exit a baggage claim area have to line up before such a barcode reader, thereby causing a bottleneck at the exit of the baggage claim area.

### SUMMARY OF SOME EMBODIMENTS OF THE INVENTION

In embodiments of the invention, a system enabling detection of unauthorized removal of a cargo item from a cargo claim area is provided.

In embodiments of the invention, the system may comprise a locking device attachable to said cargo item.

In embodiments of the invention, the locking device may comprise a transmitter adapted to transmit data wirelessly. The data may indicate whether the locking device is locked or not.

In embodiments of the invention, the system may comprise a key adapted to unlock said locking device.

In embodiments of the invention, the system may comprise one or more detectors positioned in manner such that signals transmitted from a plurality of transmitters exiting said cargo claim area are detected at the detectors.

In embodiments of the invention, the system may comprise a computing module operatively associated with the detectors. The computing module may give rise to a suitable response in case said computing module determines that data received via said signals is indicative of said locking device being locked.

In embodiments of the invention, the detectors may be adapted to detect signals from a plurality of transmitters substantially simultaneously.

In embodiments of the invention, the computing module may be adapted to process substantially simultaneously data carried over said signals detected at said detectors.

In embodiments of the invention, the computing module may be adapted to process data substantially in real-time carried over signals detected at said detectors.

In embodiments of the invention, the key may comprise one of the following items in the group: a mechanical key; a biometric input; a smartcard; and an electronic key.

In embodiments of the invention the locking device may only unlocked by entering a personal identification number (PIN).

In embodiments of the invention the locking device may store therein data related to the cargo item.

In embodiments of the invention, the key may store data related to said cargo item.

In embodiments of the invention, the locking device may include a processor adapted to determine whether the data stored in the locking device corresponds to the data stored in the key.

In embodiments of the inventions the locking device may be unlocked in case an application executed by the processor determines that that the data stored in the locking device corresponds to the data stored in the key.

In embodiments of the invention the key may be adapted unlock a plurality of locking devices.

In embodiments of the invention, key may be adapted to unlock only one locking device associated thereto.

In embodiments of the invention, the computing module may be adapted to identify a person authorized to unlock the locking device by comparing person-identifying data provided by the person with authentication data representing information about the person authorized to unlock the locking device.

In embodiments of the invention, the person authorized to unlock the locking device may be a person assigned to pick tip said cargo item from a cargo claim area.

In embodiments of the invention, the computing module may determine whether the number of unlocked devices associated to the authorized person passing the detectors, matches the number of checked-in cargo items. The computing module giving rise to a suitable response if there is a mismatch between the number of unlocked devices associated to the authorized person and the member of checked-in cargo items.

In embodiments of the invention, a method for detecting unauthorized removal of a cargo item from a cargo claim area is presented.

In embodiments of the invention, the method may comprise the step of transmitting signals from a transmitter of a locking device, said signals carrying data indicating whether said locking device is locked or not.

In embodiments of the invention, the method may include the step of detecting at detectors the signals transmitted from locking devices exiting the cargo claim area.

In embodiments of the invention, the method may include the step of triggering a suitable response from a computing module in case signals detected at the detectors carry data indicating that the locking device is in locked state.

In embodiments of the invention, the method may include the step providing a computing module with data representing cargo information associated to the cargo item.

In embodiments of the invention, the method may include the step of loading data that corresponds to said cargo item into said locking device.

In embodiments of the invention, the method may include the step of locking the locking device onto the checked-in cargo.

In embodiments of the invention, the method may include the step of determing which person is authorized to collect said cargo item. This may be accomplished by checking which data provided by persons corresponds with data representing the authorized person.

In embodiments of the invention, the method may include the step of handing out to the authorized person a key adapted to unlock the locking device.

### BRIEF DESCRIPTION OF THE DRAWINGS

The subject matter regarded as the invention will because more clearly understood in light of the ensuing description of embodiments herein, given by way of example and for purposes of illustrative discussion of the present invention only, with reference to the accompanying drawings, wherein

FIG. 1 is a schematic illustration of an isometric view of a key and a locking device in a locked state, according to some embodiments of the invention;

FIG. 2 is a schematic illustration of an isometric view of the locking device engaged with the key in unlocked and detached state, according to some embodiments of the present invention;

FIG. 3 is a schematic block diagram illustration of the locking device and the key, according to some embodiments of the invention;

FIG. 4 is a schematic illustration of a cargo item securing system, according to some embodiments of the invention; and

FIG. 5 is a flowchart of a method for securing cargo items, according to some embodiments of the present invention.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SOME EMBODIMENTS OF THE INVENTION

The present invention is a simple and highly efficient system and method for securing cargo items of, e.g., airline travelers. The system and method enable a clear identification of the owners of cargo items and of their destination and ensure that cargo items are not accidentally or intentionally taken from- a cargo claim area of, e.g., an airport terminal by people who are not the owner of the cargo items.

According to one embodiment of the present invention the system also allows locating the position of the cargo items in case they were misplaced or boarded on, e.g., the wrong aircraft.

According to some embodiments of the invention, the system includes a device which is lockable attachable to the cargo item and a key for locking and unlocking said device.

According to some embodiments of the invention, the device is locked onto the cargo item or items as they are checked in. The device may be adapted to store and/or display personal details of the person authorized to open the cargo items (hereinafter referred to as “authorized person”) and destination of the cargo item. The device may be unlocked and detached from the cargo item only by using a corresponding key which may be, for example, a programmable smart card that has been handed out to the authorized person.

In addition, the system may include detectors, which may be positioned at an exit or exits of the cargo claim area of, e.g., an airport terminal. The detectors enable determining whether the cargo item is removed from an authorized person or not, as will be outlined hereinafter.

According to some other embodiments of the invention, in case the key unlocks said device, the device and/or the key transmits data representing information that the device is unlocked, indicating that the cargo item is associated to the authorized person. Conversely, in case the device is locked, said device and/or key transmit data representing information that the device is still locked, indicating that the cargo item is not associated to the authorized person. The detectors are adapted to detect signals carrying the data transmitted from said device and/or key, thereby enabling detection of attempts of unauthorized removal of the cargo item.

It is to be understood that the term “cargo item” and variations thereof can refer to items such as, e.g., suitcases, bags, parcels, containers and the like. Furthermore, the term “cargo item” may refer to a plurality of cargo items as well.

It is to be understood that an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” refers to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

Unless specifically stated otherwise, as apparent from the following discussions, it is to be understood that utilizing terms such as “computing”, “processing”, “determining”, “calculating,” or the like, refer to the action or processes or both of a computer or computing system, or similar electronic computing device, that manipulate and/or transform data represented as physical, such as electronic quantities within the computing system's registers and/or memories into other data similarly represented as physical quantities within the computing system's memories, registers or other such transmission, information storage or display devices.

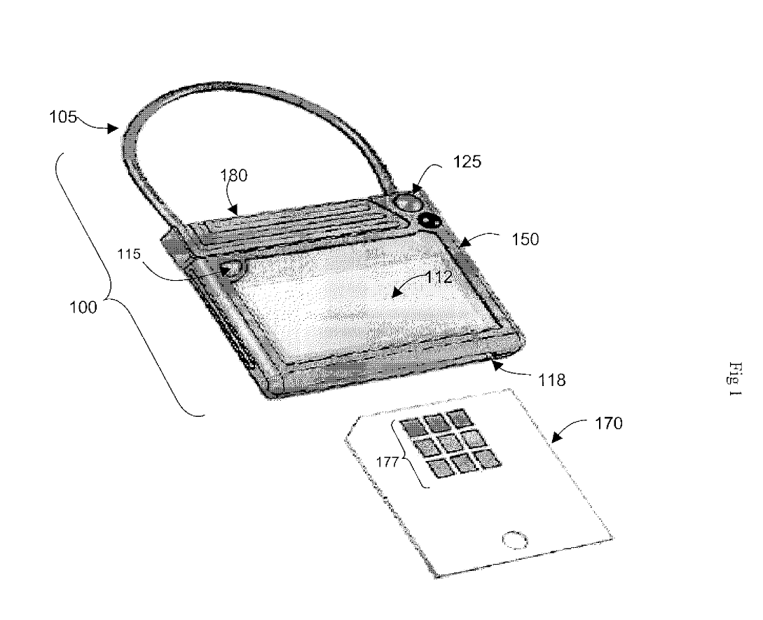

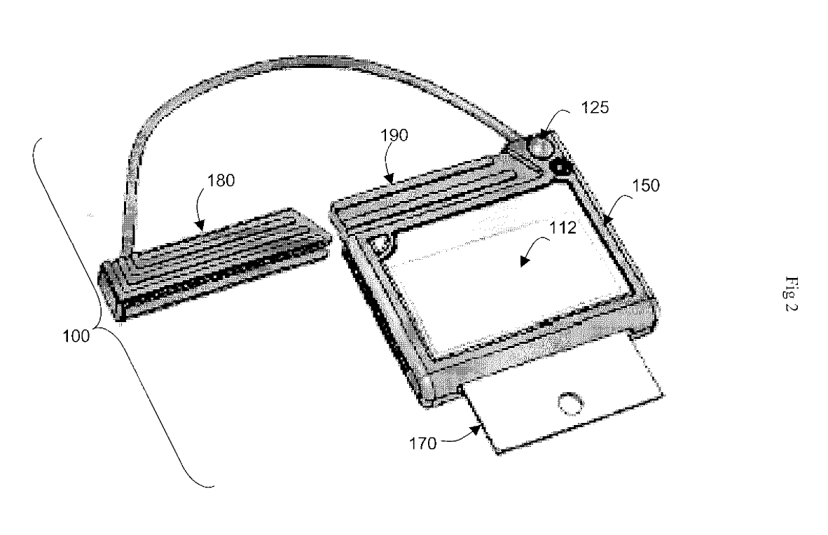

Reference is now made to FIG. 1, which schematically illustrates an isometric view of a key 170 and a locking device 100 in locked state, according to some embodiments of the present invention. Additional reference is made to FIG. 2, which schematically illustrates an isometric view of locking device 100 engaged with key 170, said locking device 100 being in unlocked and detached state, according to some embodiments of the invention.

According to some embodiments of the invention, locking device (hereinafter referred to as “device”) 100 may be adapted to be locked and/or unlocked onto a cargo item such as, luggage, bags, containers, bulky goods, parcels and the like by using key 170. it is to be understood that a key as referenced throughout the specification may be any type of key such as for example, an electronic key like, e.g., a smart card; a mechanical key employing a mechanical locking mechanism in device 100, and the like. .In some embodiments of the invention, device 100 may include an optical reading device adapted to receive biometric inputs. Accordingly, in some embodiments of the invention, key 170 may for example refer to a biometric input such as, e.g., a fingerprint and the like.

According to some embodiments of the invention, a body 150 of device 100 may include a key reader 118, which may be for example, a smart card reader, e.g., as known in the art. Key 170 matching and/or corresponding to key reader 118 may enable unlocking as well as locking of device 100, if said key 170 is suitably engaged with key reader 118. A key that does not match or is not suitably associated with key reader 118, may not unlock and/or lock device 100.

It is to be understood that known or any future versions of locking mechanism (not shown) may be implemented in device 100 and/or key 170. For example, according to some embodiments of the invention, device 100 may include a shackle 105 of which on end is attached to a detachable slide 180, and the other end to body 150, which may have a track 190. Detachable slide 180 may be locked within track 190 by, e.g., a spring lock mechanism, thereby locking shackle 105 over body 150. Accordingly, shackle 105 may be locked over, e.g., a handle of a cargo item.

According to some embodiments of the invention, device 100 may be locked by simply engaging shackle 105 with a locking mechanism (not shown) of device 100, without any requirement of engagement of key 170, though unlocking of device 100 may only be possible if key 170 is suitably engaged with corresponding key reader 118. According to some other embodiments of the invention, in order to lock device 100, key 170 has to be suitably engaged with corresponding key reader 118 as well.

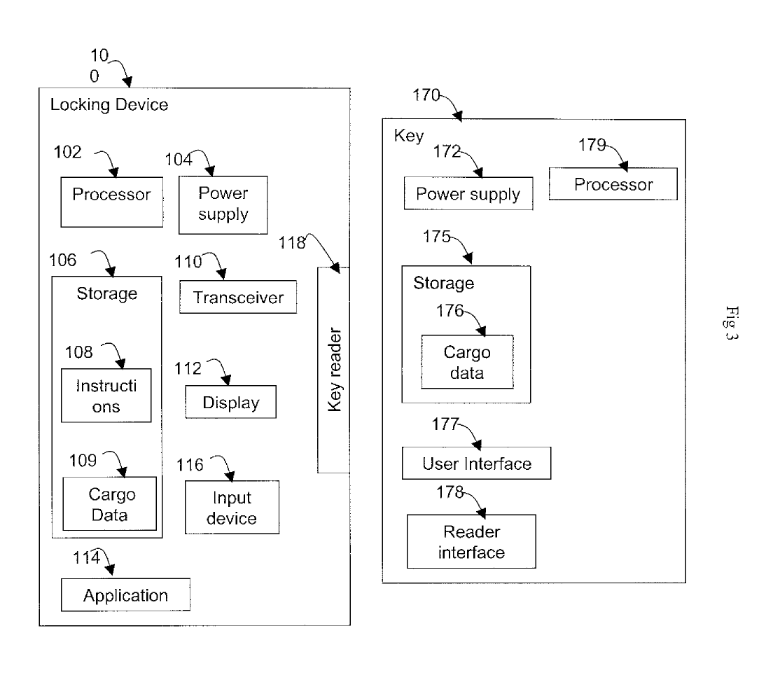

Additional reference is now made to FIG. 3, which schematically illustrates a block diagram of the device and the key, according to some embodiments of the invention.

According to some embodiments of the invention, device 100 may include, besides key reader 118, also a display 112, a processor 102, a power supply 104, a storage 106 and a transmitter 110, all of which may be operatively associated with each other. Storage 106 may be adapted to store therein data related to the cargo item to be checked in (hereinafter referred to as “cargo data 109”).

According to some embodiments of the invention, key 170 may include a storage 175 adapted to store therein data related to the cargo items to be checked in (hereinafter referred to as “cargo data 176”), a user interface 177, a reader interface 178, a processor 179 and a power supply 172, all of which are operatively associated with each other.

Processor 102 and/or storage 106 as well as processor 179 and or storage 175 may be implemented, for example, by a self Programmable One-chip Microcomputer (SPOM) architecture, e.g., as is known in the art. In some demonstrative embodiments of the invention, processor 102 and/or storage 106 as well as processor 179 and/or storage 175 may be protected by any suitable protection mechanism, e.g., any suitable “physical” protection structure and/or any other suitable protection configuration as is known in the art, to prevent the disclosure of any part of the contents of storage 106 and/or 175, to prevent any attempt to access any part of the contents of storage 106 and/or 175, to prevent any attempt to tamper or alter the contents of storage 106 and/or 175, in part or in whole, and/or to prevent any attempt to interfere with the operation of processor 102 and/or storage 106 as well as with processor 179 and/or storage 175.

According to some embodiments of the invention, in order to lock and/or unlock device 100, key 170 has to correspond to key reader 118 of device 100. Such as correspondence may refer to mechanical and/or electronic correspondence. For example, in order to unlock device 100, a user has to adjust a corresponding reader interface to key reader 118. However, in case the key does not fit mechanically into key reader 118, device 100 may not he locked and/or unlocked.

Additionally or alternatively, in order to lock and/or unlock device 100, upon adjustment of a reader interface 178 to key reader 118, processor 102 may execute instructions 108 resulting in an application 114 that, inter alia, determines whether cargo data 176 matches or suitably corresponds to cargo data 109. In case there is a match or a correspondence, device 100 may be locked and/or unlocked.

Additionally or alternatively, in order to authenticate the holder of key 170, locking and/or unlocking of device 100 may only be enabled by providing processor 102 and/or processor 179 via input device 116 or user interface 177, respectively, with a corresponding personal identification number (PIN) code. The PIN code may be a series of characters like, for example, 34, N, a, 2, $.

According to some embodiments of the invention, processor 102 is operatively associated with key reader 118 and/or the locking mechanism (not shown), such that processor 102 executing instructions 108 results in application 114 that, inter alia, determines whether device 100 is locked or not. Application 114 may further cause transmitter 110 to transmit data that is indicative of whether device 100 is locked or not. Since only the holder to key 170 may unlock device 100, unauthorized removal of cargo item 114 maybe detected, as will be outlined hereinafter.

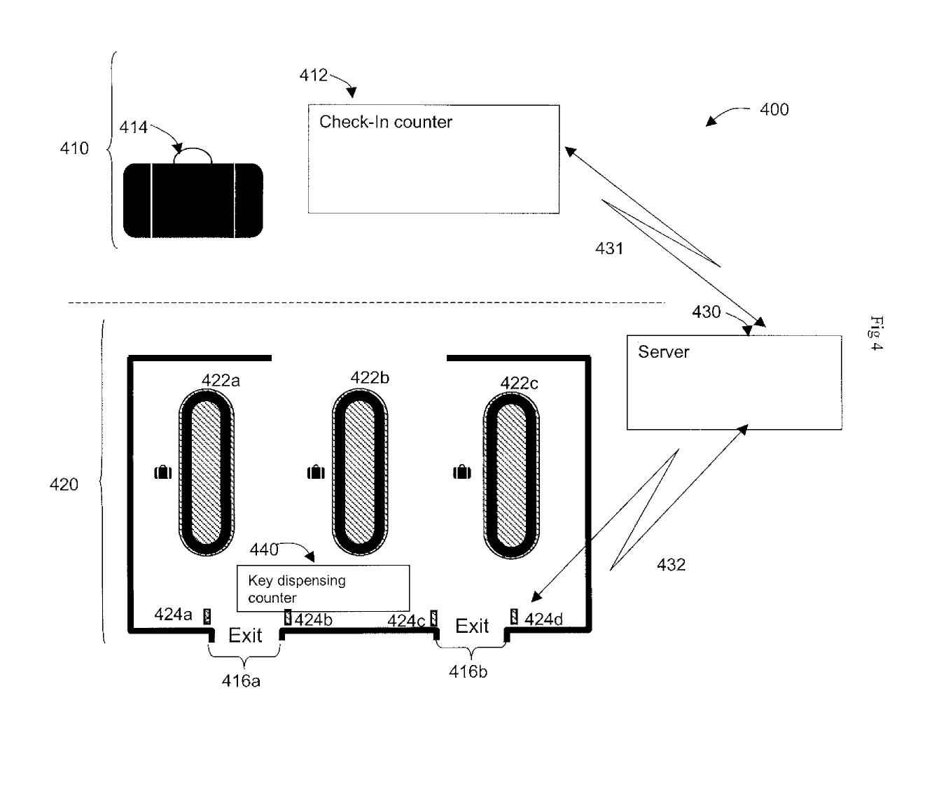

Reference is now made to FIG. 4, which schematically illustrates a cargo securing system 400, according to an embodiment of the invention.

According to some embodiments of the invention, cargo securing system 400 may include a check-in counter 412 situated in a check-in area 410. Furthermore, cargo securing system 400 may include one or more detectors, such as detectors 424a-d, suitably situated at exits of a cargo claim area 420. Optionally, cargo claim area 420 may include one or more conveyor belts, such as conveyor belts 422a-c, adapted to convey cargo item 414.

Cargo securing system 400 may further include a computing module 430, which may be, for example, a server, a workstation server, a personal computer (PC), a workstation and the like, adapted to handle cargo related data, as will be outlined hereinafter.

During the process of checking in a cargo item 414, a device such as device 100 may be uploaded with cargo data 109 representing, inter alia, information regarding the departure location, location of the destination, time and date of check-in, information about the person authorized to collect cargo item 414 such as age, address, occupation, family status, personal identification number and the like; information about the clerk serving the person checking in cargo item 414 and the like; information about a code enabling unlocking of device 100 and the like. Similarly, cargo data 176 that corresponds to and/or matches cargo data 109 may be uploaded into storage device 175 by the clerk.

According to some embodiments of the invention, cargo data 109 and/or cargo data 176 may be uploaded to storage 106 and/or 175, respectively, from server 430.

According to some embodiments of the invention, data may be uploaded only once into storage 106 AVRND/or 175. Accordingly, device 100 and/or key 170 may be not be reused, thereby diminishing the chances of fraudulent use of device 100 and/or key 170.

According to some embodiments of the invention, device 100 may be locked onto cargo item 414 by, e.g., the clerk, and key 170 is handed out to the authorized person, which may be the owner of cargo item 414, or to any other person authorized to collect cargo item 414 at its destination. Cargo item 414 may then be conveyed to a transportation means, which may be, for example, a ship, a plane and the like.

According to some embodiments of the invention, key 170 may be adapted to lock and/or unlock a plurality of devices associated with the authorized person.

According to some other embodiments of the invention, a key may correspond or be able to lock and/or unlock only one device. Accordingly, the number of keys handed out to the authorized person may correspond to the number of locking devices, i.e., to the number of checked-in cargo items.

According to some embodiments of the invention, data representing information about the check-in process, such as time of check-in and the like may be transmitted to computing module 430.

According to some embodiments of the invention, transmitter 110 may transmit substantially continuously data about the transmitter's 110 location to computing module 430 via, e.g., a satellite connection, by employing, for example, a global positioning system (GPS).

According to some embodiments of the invention, cargo item 414 may be collected at its destination in cargo claim area 420. According to some embodiments of the invention, application 114 may cause display 112 to display the name and/or other information about cargo item 414 such as ownership, origin and/or destination and the like, thereby facilitating identification of cargo item 414 by the authorized person.

According to sonic embodiments of the invention, one or more detectors, such as detectors 424a-d, may be located at an exit, such as exit 416a and/or 416b, of cargo claim area 420. Detectors 424a-d may be operatively associated with computing module 430. Detectors 424a-d are adapted to detect signals transmitted from devices like device 100, passing detectors 424a-d. Data carried by the signals detected at detectors 424a-d may be sent over signal 432 to server 430.

According to some embodiments of the invention, detectors 424a and/or 424b are adapted to register signals of a plurality of devices passing substantially simultaneously said detectors 424a-d. Signals detected at detectors 424a-d may be transmitted to computing module 430 via, e.g., a satellite communication network. Computing module 430 may also be adapted to process substantially simultaneously data carried over the signals that are detectors at detectors 424a-d. Furthermore, computing module 430 may be adapted to process substantially in real-time data carried over signals detected at detectors 424a-d.

As already mentioned hereinabove, in case device 100 is in locked state, processor 102 may execute instructions 108 resulting in application 114, which, inter alia, gives rise to the transmission of data that corresponds to the locked state of device 100. Conversely, in case 100 is in unlocked state, processor 102 may execute instructions 108 resulting in application 114, which, inter alia, gives rise to the transmission of data that corresponds to the unlocked state of device 100. Computing nodule 430 may be adapted to determine whether the data received from a transmitter via detectors origins from a device that is locked or not. As already mentioned hereinabove, a device, such as device 100, may only be unlocked by the holder of a corresponding and/or matching key, which is the authorized person. Accordingly, if computing module 430 receives data that corresponds to a locked state of device 100, said data is indicative of an attempt of unauthorized removal of cargo item 414 from cargo claim area 420. As a result, computing module 430 may initiate triggering a suitably response such as an alarm in, for example, cargo claim area 420 to give notice to, e.g., security personnel patrolling said cargo claim area 420.

Conversely, if computing module 430 receives data that corresponds to an unlocked state of device 100, said data is indicative of authorized removal of cargo item 414 from cargo claim area 420.

According to some embodiments of the invention, device 100 may include a buzzer (not shown) that is operatively associated with computing module 430, adapted to sound an alarm signal in case someone make an attempt of unauthorized removal of cargo item 414 from cargo claim area 420.

According to some embodiments of the invention, computing module 430 may determine whether the number of unlocked devices associated to the authorized person passing detectors 424a-d, matches the number of cargo items that have been checked in. This may be accomplished by comparing the number of devices associated to the authorized person with the number of checked-in cargo items associated to the authorized person. The number of devices associated to the authorized person passing detectors 424a-d, may be determined by, e.g., computing module 430, based on the signals detected at said detectors 424a-d.

According to some embodiments of the invention, cargo securing system 400 may include a key dispensing counter 440, which may be located in, e.g., cargo claim area 420. Key dispensing counter 440 may be adapted to receive from, e.g., computing module 430, data representing information about cargo items checked-in at, e.g., counter 412, and the person authorized to collect the checked-in cargo items. Key dispensing counter may receive said data via, e.g., signal 432. Key 170 may be handed out at the key dispensing counter 440 only to a person identified as the authorized person. Accordingly, cargo system 400 enables secure collection of cargo items by persons who did not perform the process of checking-in said of cargo items.

It is to be understood that key dispensing counter 440 may receive signals carrying data representing cargo-related data from a plurality of computing modules and/or check-in counters.

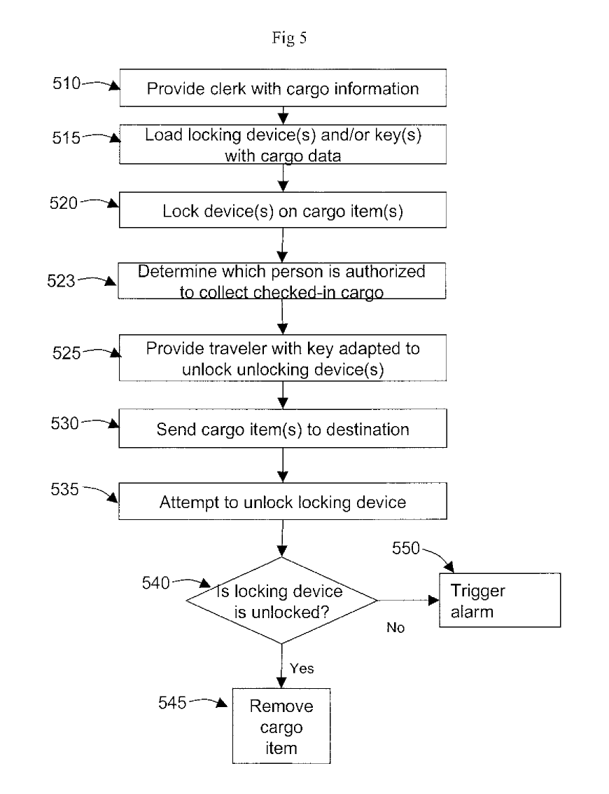

Reference is now made to FIG. 5, which schematically illustrates a flowchart of a method for securing cargo items, according to some embodiments of the invention.

As indicated by box 510, the method may include, for example, the step of providing computing module 430 with data representing cargo information such as information about the destination of cargo item 414, personal details of the authorized user and the like. This may accomplished, for example, by providing the clerk with an identification card, a flight ticket comprising information about the destination of the travel and the like. The cargo information may then be sent via from check-in counter 412 via, e.g., signal 431, to computing module 430.

As indicated by box 515, the method may include, for example, the step of uploading data representing information about, for example, checked-in cargo item 414, into device 100 and/or key 170.

As indicated by box 520, the method may include, for example, the step of locking a device onto a cargo item. For example, device 100 may be locked onto cargo item 414. This may be accomplished, for example, by employing a spring-lock mechanism between shackle 105 and body 150 of device 100. In some embodiments of the invention, only upon suitable adjustment and removal of key 170 into and from device 100, said device may be locked.

As indicated by box 523, the method may include, for example, the step of identifying the person that is authorized to collect checked-in cargo item 414. This may be accomplished, for example, by determining whether personal data provided by a person corresponds and/or matches to data representing the authorized person.

As indicated by box 525, the method may include, for example, the step of handing out to the authorized user a key such as key 170 adapted to unlock, for example, cargo item 414.

According to some embodiments of the invention, the authorized person may be a traveler traveling to the same destination like cargo item 414. According to some other embodiments of the invention, key 170 may not be handed out to the person checking in cargo item 414. Instead, the authorized person may be located at the destination of cargo item. 414, and cargo data 176 may be sent to, e.g., key dispenser counter 440 via, e.g., signals 431 and 432. In order to be able to collect key 170, said authorized person may have to provide e.g., computing module 430 with data that corresponds to authentication data.

According to some embodiments Of the invention, data may only be once uploaded into key 170, i.e., key 170 may not be reusable. Accordingly, chances of fraudulent use in case of theft of key 170 are decreased.

As indicated by box 530, the method may include, for example, the step of sending cargo item 414 to its destination. This may be accomplished, e.g., as known in the art. In some embodiments, the person the checked in cargo item 414 may also be the authorized user, which may also travel to the same destination as cargo item 414 by e.g., embarking or emplaning to said destination. In some other embodiments of the invention, the authorized user may be a person different from the person that checked in cargo item 414.

As indicated by box 535, the method may include, for example, the step of attempting to unlock a device at the destination of, e.g., cargo item 414 by, for example, adjusting key 170 to device 100.

As indicated by box 540, the method may include, for example, determining whether device 100 is unlocked or not by, e.g., computing module 430, based on the data received over the signals detected at, e.g., detectors 424a-d. This, since the information represented by the data transmitted over signals from transmitter 110 may depend on whether device 100 is locked or not.

As indicated by box 550, in case a device such as, e.g., device 100 is locked; the method may include the step of triggering an alarm. The alarm may be triggered at device 100, in a control room of cargo claim area 420, in cargo claim area 420 itself, at mobile stations such as pagers, personal digital assistants (PDAs) and the like carried by, e.g., security personnel patrolling cargo claim area 420, or at any other suitable location.

As indicated by box 545, in case a device such as device 100 is unlocked, the method may include the step of authorized removal of cargo item 414 from cargo claim area 420.

Reference is now made again to FIG. 3. According to some embodiments of the invention, due to legal restrictions, transmitter 110 may be configured to operate only when device 100 is on the ground to avoid interfering communication during the flight.

According to some embodiments of the invention, transmitter 110 may operate locally in the vicinity of the airport terminal and communicate with the information system of the airline. If, for instance, the baggage item is sent to the wrong destination, device 100 may then be located by, e.g., computing module 430.

Embodiments of the invention may be implemented in a variety of environments and application as system 400, device 100 and/or key 170 may be utilized in parcel delivery services as well.

According to an additional embodiment of the present invention the key 170 is not inserted into the device but externally connects to locking device 100. Alternatively, key 170 may communicate with the device 100 using any type of wireless short range communication, such as Bluetooth, infrared communication and the like.

According to some embodiments of the invention, device 100 also comprises a push button 125 operatively associated to light sources (not shown). Pressing push button 125 may light up display 112, thereby enabling seeing information about the destination, origin and the like of cargo item 414 in dark surroundings.

According to some embodiments of the invention, device 100 may comprise a button 115 operatively associated with processor 102 in manner such that, pressing button 115 sets device 100 into operation, and repeated pressing may turn off device 100.

It is to be understood that some embodiments of the invention may be implemented, for example, using a machine-readable medium or article which may store an instruction or a set of instructions that, if executed by a machine, cause the machine to perform a method or operations or both in accordance with embodiments of the invention. Such a machine may include, for example, any suitable processing platform, computing platform, computing device, processing device, computing system, processing system, computer, processor, or the like, and may be implemented using any suitable combination of hardware or software or both. The machine-readable medium or article may includes but is not limited to any suitable type of memory unit, memory device, memory article, memory medium, storage article, storage device, storage medium or storage unit such as, for example, memory, removable or non-removable media, erasable or non-erasable media, writeable or re-writeable media, digital or analog media, optical disk, hard disk, floppy disk, Compact Disk Recordable (CD-R), Compact Disk Read Only Memory (CD-ROM), Compact Disk Rewriteable (CD-RW), magnetic media, various types of Digital Versatile Disks (DVDs), a tape, a cassette, or the like. The instructions may include any suitable type of code, for example, an executable code, a compiled code, a dynamic code, a static code, interpreted code, a source code or the like, and may be implemented using any suitable high-level, low-level, object-oriented, visual, compiled or interpreted programming language. Such a compiled or interpreted programming language may be, for example, C, C++, Java, Pascal, MATLAB, BASIC, Cobol, Fortran, assembly language, machine code and the like.

It should be noted that embodiments of the invention may be used in at variety of applications. Non-limiting examples of embodiments of the invention include the usage of the invention in conjunction with many networks. Non-limiting examples of such networks include a wide area network (WAN), local area network (LAN), a global communication network, e.g., the Internet, a wireless communication network such as, for example, a wireless LAN (WLAN) communication network, a wireless virtual private network (VPN), a Bluetooth network, a cellular communication network, for example, a 3rd Generation Partnership Project (3GPP), such as, for example, a Global System for Mobile communications (GSM) network, a Wideband Code Division Multiple Access (WCDMA) cellular communication network, (a Frequency Domain Duplexing (FDD) network, a network based on infrared light, radio frequency identification and the like.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While the invention has been described with respect to a limited number of embodiments, these should not be construed as limitations on the scope of the invention, but rather as exemplifications of some of the embodiments. Those skilled in the art will envision other possible variations, modifications, and programs that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A system enabling detection of unauthorized removal of a cargo item from a cargo claim area, said system comprising:
a) a locking device attachable to said cargo item; wherein said locking device comprises a transmitter adapted to transmit data wirelessly, said data being indicative on whether said locking device is locked or not;
b) a key adapted to unlock said locking device;
c) one or more detectors positioned in an manner such that wireless signals transmitted from a plurality of transmitters exiting said cargo claim area are detected at said detectors; and
d) a computing module operatively associated with said detectors, said computing module giving rise to a suitable response in case said computing module determines that data received via said signals is indicative of said locking device being locked.

2. The system of claim 17 wherein said detectors are adapted to detect signals from a plurality of transmitters substantially simultaneously.

3. The system of claim 1, wherein said computing module is adapted to process substantially simultaneously data carried over said signals detected at said detectors.

4. The system of claim 1, wherein said computing module is adapted to process substantially in real-time data carried over said signals detected at said detectors.

5. The system of claim 1, wherein said key comprises one of the following group:
e) a mechanical key;
f) a biometric input;
g) a smartcard; or
h) an electronic key.

6. The system of claim 1, wherein said locking device is unlocked by entering a personal identification number (PIN).

7. The system of claim 1, wherein said locking device stores therein data related to said cargo item.

8. The system of claim 1, wherein said key stores data related to said cargo item.

9. The system of claim 1, wherein said locking device includes a processor adapted to determine whether the data stored in the locking device corresponds to the data stored in the key.

10. The system of claim 9, wherein said locking device is unlocked in case an application executed by said processor determines that that the data stored in the locking device corresponds to the data stored in the key.

11. The system of claim 1, wherein said key is adapted unlock a plurality of locking devices.

12. The system of claim 1, wherein said key is adapted to unlock only one locking device associated thereto.

13. The system of claim 1, wherein said computing module is adapted to identify a person authorized to unlock said locking device by comparing person-identifying data provided by said person with authentication data representing information about the person authorized to unlock said locking device.

14. The system of claim 13, wherein said person authorized to unlock said locking device is a person assigned to pick up said cargo item from a cargo claim area.

15. The system of claim 1, wherein said computing module determines whether the number of unlocked devices associated to the authorized person passing said detectors, matches the number of checked-in cargo items, said computing module giving rise to an alarm if there is a mismatch between the number of unlocked devices associated to the authorized person and the number of checked-in cargo items.

16. A method for detecting unauthorized removal of a cargo item from a cargo claim area, said method comprising the steps of:
transmitting signals from a transmitter of a locking device, said signals carrying data indicating whether said locking device is locked or not;
detecting at detectors said signals transmitted from locking devices exiting said cargo claim area; and
triggering a suitable response from a computing module in case signals detected at said detectors carry data indicating that said locking device is in locked state.

17. The method of claim 16 further comprising the steps of:
i) providing a computing module with data representing cargo information associated to said cargo item;
j) loading data that corresponds to said cargo item into said locking device
k) locking said locking device onto said checked-in cargo;
l) determining which person is authorized to collect said cargo item, by checking which data provided by persons corresponds with data representing said authorized person;
m) handing out to said authorized person a key adapted to unlock said locking device;

18. The method of claim 16, wherein said detectors are adapted to detect signals from a plurality of transmitters substantially simultaneously.

19. The method of claim 16, wherein said computing module is adapted to process substantially simultaneously data carried over said signals detected at said detectors.

20. The method of claim 16, wherein said computing module is adapted to process substantially in real-time data carried over said signals detected at said detectors.
